(19) United States
(12) Patent Application Publication
(10) Pub. No.: US 2025/0279237 A1
(43) Pub. Date: Sep. 4, 2025

(54) METHOD FOR PRODUCING A MAGNETICALLY SEPARATE CORE TUBE AND MAGNETIC-ARMATURE DEVICE WITH THE CORE TUBE

(71) Applicant: ETO MAGNETIC GmbH, Stockach (DE)

(72) Inventors: Matthias Bechler, Singen-Friedingen (DE); Julia Wütherich, Stockach (DE)

(21) Appl. No.: 18/257,777

(22) PCT Filed: Dec. 14, 2021
(86) PCT No.: PCT/EP2021/085697

§ 371 Date: Jun. 19, 2024

(30) Foreign Application Priority Data
Dec. 16, 2020 (DE) 10 2020 133 834.1

(51) Int. Cl. H01F 41/32; H01F 3/14; H01F 41/02

(52) U.S. Cl. CPC H01F 41/32; H01F 3/14; H01F 41/0206

(57) ABSTRACT

In a method for producing a core tube for a magnetic actuator, which has, at least along a longitudinal direction of the core tube, a preferably pressure-tight magnetic separation, in at least one method step, a separating element, which produces the magnetic separation of the core tube and is made of a non-magnetic material, is inserted into the core tube by material bonding by means of laser-powder deposition welding, and in at least one preparatory step, a core tube blank is provided on its outer circumference with a circumferential groove into which the separating element is inserted in the method step,
wherein in the method step, the non-magnetic material is blown in powder form into a laser beam, is melted in the laser beam and then in already melted form is introduced into the groove.

### PRIOR ART

The invention concerns a method according to the preamble claim 1, a magnetic actuator device according to the preamble of claim 11, and a magnetic actuator according to claim 16.

It has already been proposed to provide core tubes with a pressure-tight magnetic separation. Previously, this separation was created by welding processes, e.g. deposition welding or condenser discharge welding, or by soldering processes, e.g. MIG soldering or hard soldering, wherein an (annular) separating element made of non-magnetic material is inserted in the core tube. In all methods previously used, the core tube is exposed to high temperatures. Therefore fine cone geometries at the transition between a magnetic main body of the core tube and the non-magnetic inserted separating element are damaged or destroyed, e.g. by partial melting. Previously therefore, a costly and extensive technical complexity was required for implementation, control and/or monitoring of the welding or soldering processes used, in order to keep the damage to the cone geometry as small as possible.

Also, the welding or soldering processes described create uneven surfaces at an outer circumference of the separating element, and/or surfaces protruding beyond the outer circumferential geometry of the core tube, which can reduce the function capacity/installation ability of the core tube and must therefore be carefully removed, smoothed and/or adapted to the outer circumferential geometry of the core tube.

The object of the invention is in particular to create a generic method with advantageous properties with respect to a production of magnetically separate core tubes, in particular retaining fine cone geometries, and with preferably simultaneously low production costs. This object is achieved according to the invention with the features of claims 1, 11 and 16, while advantageous embodiments and refinements of the invention are described in the dependent claims.

### ADVANTAGES OF THE INVENTION

The invention is based on a method for producing a core tube for a magnetic actuator, which has, at least along a longitudinal direction of the core tube, a preferably pressure-tight, magnetic separation.

According to the invention, in at least one method step, a separating element, which produces the magnetic separation of the core tube and is made of a non-magnetic material, in particular a non-magnetic metal, is inserted into the core tube by material bonding by means of laser-powder deposition welding. Thus in particular, an advantageous production of the magnetically separate core tube can be achieved. Advantageously, thereby a temperature to which parts of the core tube are exposed during insertion of the separating element can be kept low, preferably so low that melting of the core tube and hence in particular damage to the core tube and/or a magnetic field conduction contour of the core tube, in particular in the connecting region between core tube and separating element, can be avoided. At the same time however, advantageously, the temperature can be selected sufficiently high to guarantee a good pressure-tight connection of the separating element to the core tube. Advantageously, a particularly good and/or durable connection of the core tube to the separating element can be achieved. Advantageously, the laser powder deposition welding allows precise control of an energy input generated via a laser and hence a precise temperature control of the method. Advantageously, in contrast to the methods of the prior art in which usually too much material is melted in the magnetic separation to achieve a process-reliable substance bonding over an entire region of the core tube covered by the separating element, a precise adaptation of the melted material quantity to the respective core tube geometry can thus be achieved. Advantageously, thereby there is no need for later machining following the insertion of the separating element in the core tube, for example material removal work on the outer circumference of the separating element. Advantageously, the laser powder deposition welding may achieve a smooth and/or flat surface on the outer circumference of the separating element, in particular without subsequent material removal, e.g. by turning or over-turning the outer circumference of the separating element. Advantageously, by controlling the energy input generated via a laser, the surface of the separating element on the outer circumference can already be smoothed during insertion of the separating element in the core tube. Also, advantageously, a particularly high pressure-tightness of the core tube comprising the separating element, in particular also at the connecting points between core tube and separating element, can be guaranteed. Thus advantageously, a particularly good suitability of the core tube for magnetic actuators in hydraulic applications can be achieved. Advantageously, it may be ensured that the separating element is continuously connected to the core tube by substance bonding in the contact regions to the core tube.

A “core tube” in particular means a component of a magnetic actuator made of an in particular soft magnetic, preferably ferromagnetic material which conducts and bundles magnetic flux, and at least for the most part forms a magnetic core of the magnetic actuator, and/or which at least partially, preferably at least for the most part, is arranged in a coil interior of a magnetic coil of the magnetic actuator. In particular, the magnetic material is realized as a magnetic substance. In particular, the core tube is at least for the most part made of a magnetic steel. In particular, the core tube, together with at least one magnetic coil of the magnetic actuator, forms an inductance. In particular, the core tube is at least partially and/or at least unilaterally tubular. In particular, the core tube is intended to at least partly receive a magnetic armature of the magnetic actuator. In particular, the core tube is intended to at least partly form a stroke volume for the magnetic armature of the magnetic actuator. In particular, the stroke volume for the magnetic armature is formed by the tubular part of the core tube. In particular, the longitudinal direction of the core tube runs parallel to a tube axis, in particular an axis of rotational symmetry, of the tubular part of the core tube. In particular, in a state mounted in the magnetic actuator, the longitudinal direction of the core tube runs parallel with a coil axis of the magnetic coil of the magnetic actuator. A “magnetic actuator” in this context in particular means a device which is configured for converting an electrical power into a mechanical power by means of a magnetic field.

The term “configured” in particular means specially programmed, designed and/or equipped. The phrase that an object is configured for a specific function in particular means that the object fulfils and/or executes the specific function in at least one application and/or operating state. “For the most part” means in particular 51%, preferably 66%, preferably 75% and particularly preferably 90%. A “substance-bonded connection” in particular means that the mass parts are held together by atomic or molecular forces. The phrase “pressure-tight” in particular means pressure-tight at conventional hydraulic pressures, preferably pressure-tight at least at pressures of more than 100 bar, advantageously pressure-tight at pressures of more than 200 bar, preferably pressure-tight at pressures of more than 300 bar, and particularly preferably pressure-tight at pressures of more than 500 bar. Preferably, the connection between the separating element and the main body of the core tube is realized in such a way that, even at high pressures in the interior of the core tube (e.g. at pressures as listed above), no liquid and/or gas can escape from the core tube at the connection.

A “magnetic separation” of the core tube in particular means that two part regions (formed from a magnetic material) of the core tube are separated from one another such that at least a majority of all magnetic field lines running in the first part region of the core tube are prevented from crossing over directly into the second part region of the core tube. A “magnetic separation” of the core tube in particular means an interruption in the magnetic flux conductivity of the core tube. In particular, the separating element is configured to create the magnetic separation of the core tube, in particular in the longitudinal direction of the core tube. In particular, the separating element is configured to interrupt the magnetic flux through the core tube in the longitudinal direction. In particular, the separating element is configured to divert the magnetic field lines of the magnetic field of the magnetic coil such that, in the region of the transition from the core tube to the separating element, the magnetic field lines are conducted out of the core tube. In particular, the separating element is arranged in a region of the core tube which, in mounted state of the magnetic actuator, is arranged in the coil interior of the magnetic coil. In particular, the separating element is arranged in a region of the core tube which, in mounted state of the magnetic actuator, forms the stroke volume for the magnetic armature. In laser powder deposition welding, in particular a powdery additive material—which preferably, in completed state, forms the separating element—is melted with laser energy and thereby welded onto an existing component, for example the core tube. Advantageously, thereby a pore-free and crack-free layer, and/or a pore-free and crack-free element such as the separating element, is here produced in particular with low mixing and with a small heat influence zone. In particular, in laser powder deposition welding, the separating element is inserted by substance bonding between two magnetic part regions of the core tube which are separated from one another in the longitudinal direction. In particular, the component of the magnetic actuator formed from the two part regions of the core tube and the separating element is formed as an integral and/or one-piece component. In particular, the separating element also serves for stabilizing and/or sealing the core tube.

Furthermore, according to the invention, in at least one preparatory step, preferably performed before the method step, a core tube blank, which in particular will form the core tube in the completed state, is provided on its outer circumference with a circumferential groove into which the separating element is inserted in the method step. Thus an advantageous production process is possible. Advantageously, thereby the separating element can easily be introduced into the core tube. Advantageously, a simple and/or precise positioning and/or design of the separating element is possible. In particular, in the preparatory step, the circumferential groove is turned into the core tube blank. Alternatively however, it is also conceivable that in the method step, a core tube blank already containing the groove is cast. In particular, the core tube blank is formed as a massive, in particular at least substantially cylindrical solid part, preferably a steel part. Alternatively, the core tube blank is formed as an at least partly hollowed out and/or at least partially tubular part, preferably a steel part. In this case, the core tube blank is realized in particular as a drawn steel tube. In particular, the outer circumference of the core tube blank is formed by a casing surface, in particular a cylinder casing surface of the core tube blank.

It is also proposed that in the preparatory step, at least one side boundary of the groove is provided with a magnetic field conduction contour, which in particular will form a cone geometry of the completed core tube for influencing and/or design of a force-travel curve of the magnetic actuator having the core tube. Thus an advantageous production process is possible. Advantageously, by choice of form of the magnetic field conduction contour, a force-travel curve of the magnetic actuator having the completed core tube can be established. In particular, the side boundary delimits the groove at least substantially in a direction running parallel to the longitudinal direction. In particular, at least the side boundary of the groove which delimits the groove towards the magnetic core and/or in a direction pointing away from the magnetic armature, is provided with the magnetic field conduction contour. In particular, the magnetic field conduction contour is arranged on a side of the groove facing the magnetic core. In particular, the magnetic field conduction contour is formed as a succession of edges, angles and/or radii. In particular, the magnetic field conduction contour comprises at least two different radii. In particular, the magnetic field conduction contour comprises at least two edges. It is however also conceivable that the magnetic field conduction contour has only one edge and two faces, or only one radius and two faces, or similar. In particular, the magnetic field conduction contour is realized in such a way that a particularly good and/or particularly loss-free transition of the magnetic field from the magnetic core to the magnetic armature is possible. In particular, the form of the magnetic field conduction contour is determined in a calculation and/or simulation step. In particular, the magnetic field conduction contour may take different forms depending on the respective desired force-travel curve of the magnetic actuator. In particular, the magnetic field conduction contour, in particular the cone geometry, remains at least substantially unchanged in its form during the laser powder deposition welding. The phrase “substantially unchanged” in particular means that deviations of the magnetic field conduction contours before and after performance of the laser powder application welding, at any point of the magnetic field conduction contour, are smaller than 0.2 mm, preferably smaller than 0.1 mm and particularly preferably smaller than 0.05 mm. In particular, the magnetic field conduction contour is rotationally symmetrical. In particular, the magnetic field conduction contour is turned into the core tube. In particular, one of the side boundaries, with the side boundary of the groove opposite the magnetic field conduction contour, is free from a magnetic field conduction contour.

In a method known from the prior art, the non-magnetic material is blown into the groove in powder form and then melted by a laser beam, in particular to form the separating element.

According to the invention however, in the method step, non-magnetic material in powder form is blown into a laser beam, melted in the laser beam and then in already melted form introduced into the groove. Thus advantageously, a particularly high production speed can be achieved, in particular in that higher melting powers and/or shorter process times can be achieved. The non-magnetic material in powder form is thus already melted “in flight”, and in liquid form hits the surface of the core tube blank in the region of the groove. Advantageously thereby, in comparison with the prior art, substantially more material can be melted and introduced into the groove, whereby advantageously a process time can be significantly shortened.

It is furthermore proposed that in the method step, the powdery non-magnetic material blown into the laser beam and melted in the laser beam is realized as a non-magnetic metal powder. Thereby advantageously, properties with respect to pressure-tightness and/or stability can be achieved, in particular since then the separating element is also metallic. The non-magnetic material of the non-magnetic metal powder must in particular be sufficiently non-magnetic to be able to function as a magnetic separation of the core tube. The non-magnetic material of the non-magnetic metal powder must in particular, in the melted and re-hardened state, have sufficient strength to be able to guarantee a stable implementation of the core tube. For example, the powdery non-magnetic material blown into the laser beam and melted in the laser beam in the method step may be implemented as a metal powder of a non-magnetic special steel, a metal powder of an aluminum bronze, a metal powder of an aluminum alloy, a metal powder of a bronze, and/or a metal powder of a CuSi alloy. In this context, a “special steel” means an alloyed or unalloyed steel with high degree of purity, in particular with a purity degree of which the mass proportion of ferrous impurities is less than 0.025%. Preferably, the special steel meets the requirements of a stainless steel and/or is realized as a stainless steel. Preferably, the special steel is implemented as a stainless steel with an at least mainly austenitic structure, preferably with an almost exclusively austenitic structure.

It is also proposed that, in at least one further method step, after insertion of the separating element into the groove, an armature receiving recess is produced, in particular drilled and/or turned, into the core tube blank and preferably extends beyond the groove in the longitudinal direction, in particular of the core tube. Thus an advantageous production process of the magnetically separated core tube can be achieved. Advantageously thereby, the separating element can easily be introduced between two completely or almost completely separate part regions of the core tube, in particular of the main body of the core tube. The armature receiving recess, in particular at least in mounted state of the magnetic actuator, is configured for receiving the magnetic armature. The armature receiving recess in particular forms the stroke volume for the magnetic armature. In particular, the armature receiving recess extends between the magnetic core and an armature stop element of the magnetic actuator.

If in the further method step, on production of the armature receiving recess, the core tube blank is hollowed out down to a groove bottom of the groove, advantageously a simple complete separation can be achieved of the two part regions of the core tube, in particular of the main body of the core tube, which are spaced apart from one another in the longitudinal direction. Advantageously, a particularly good magnetic separation can be achieved of two part regions of the core tube which are spaced apart from one another in the longitudinal direction. Advantageously, a particularly effective transition of the magnetic field from the magnetic core to the magnet armature can be achieved.

If alternatively, in the further method step, on production of the armature receiving recess, the core tube blank is hollowed out until only a thin web of the material of the core tube blank remains between a groove bottom of the groove and an inner surface of the armature receiving recess, in particular a web with a thickness of less than 0.5 mm and preferably less than 0.2 mm, advantageously a particularly good pressure-tightness can be achieved with simultaneously adequate magnetic separation. In particular, a magnetic field saturation is reached very quickly in the remaining thin web, so that the deterioration of the magnetic properties of the entire system caused by the remaining thin web is negligibly slight. It is conceivable that the hollowing-out of the core tube blank is executed already before performance of the method step with the laser powder deposition welding.

Furthermore, in a further alternative of the invention, it is proposed that the core tube blank, in which the groove is produced in the preparatory step, is embodied as a drawn tube which already has an armature receiving recess. Thus the armature receiving recess is produced without material removal. Thereby advantageously, there is no need for internal material-removal machining of the core tube, in particular the core tube blank. Also, a drawn tube has inner surfaces which are particularly advantageous with respect to friction with the magnetic armature, and which in particular are reduced in comparison with an inner surface produced by material removal.

Also it is proposed that, in the method step, the separating element is inserted in a groove of the core tube so precisely that a surface of the separating element and a surface of the core tube transform evenly into one another. Thus advantageously, subsequent machining of the outer circumference with material removal may be omitted. Advantageously, thereby a process speed can be increased and the process costs reduced. In particular, the transition between the surface of the separating element and the surface of the core tube is free or at least almost free from shoulders. Preferably, a shoulder at the transition between the surface of the separating element and the surface of the core tube is smaller than 0.5 mm, preferably smaller than 0.2 mm. In particular, it is conceivable that the separating element tapers in the middle region. In this case, the surface of the core tube transforms evenly and/or without shoulders, preferably in both axial end regions, into the surface of the separating element, and then the separating element tapers at least in a middle region of the separating element. The outer geometry of the separating element which tapers in the middle region fulfils this task like a separating element with a completely flat surface, but can be produced significantly more easily and at lower cost.

In addition, it is proposed that in at least one method step, after completion of the insertion and at least partial hardening of the separating element, in particular of the non-magnetic material introduced into the groove, the laser beam or a further laser beam is again passed over a surface of the separating element, in particular a radially outwardly facing surface of the non-magnetic material introduced into the groove, in order thereby to smooth and/or equalize the surface of the separating element by a further, at least partial melting of the separating element, in particular in a surface region of the separating element. Thereby advantageously, a subsequent machining at the outer circumference may be omitted. Advantageously, thereby a process speed can be increased and process costs reduced. Advantageously, a flat and/or shoulderless transition from the core tube to the separating element can easily be created and/or ensured.

Furthermore, a magnetic actuator device with the core tube is proposed, which is at least substantially magnetically separated along its longitudinal direction by the separating element, wherein the separating element is introduced into the core tube by substance bonding by means of the laser powder deposition welding. Thus advantageously, a magnetic actuator device can be created with an advantageously magnetically separated and also pressure-tight core tube. A “magnetic actuator device” in this context in particular means at least a part, in particular a sub-assembly, of the magnetic actuator. Advantageously, the magnetic actuator device is intended at least for use in a hydraulic system. In particular, the magnetic actuator device may also comprise an actuator housing, advantageously formed as an outer housing, in particular at least for receiving the core tube, the magnetic armature and/or magnetic coil. It is furthermore proposed that at an interface to the separating element, the core tube has an in particular circumferential magnetic field conduction contour, which in particular forms a cone geometry for influencing a force-travel curve of a magnetic actuator having the core tube. Thus in particular, an advantageous magnetic field form may be achieved for setting a desired course of the force-travel curve of the magnetic actuator.

It is also proposed that the separating element is arranged in a region of an armature receiving recess of the core tube. Thus in particular, an advantageous magnetic field form may be achieved for setting a desired course of the force-travel curve of the magnetic actuator. If the separating element extends from the outer circumference of the core tube to an inner circumference of the armature receiving recess, advantageously a particularly effective magnetic separation of the core tube can be achieved, in particular of the two part regions of the core tube.

If, alternatively, the separating element extends from an outer circumference of the core tube towards the armature receiving recess, wherein the separating element is separated from the armature receiving recess by a thin web formed by the core tube, in particular with a thickness of less than 0.5 mm, preferably less than 0.2 mm, advantageously a particularly high pressure-tightness can be achieved with simultaneously sufficiently good magnetic separation of the two part regions of the core tube.

Furthermore, a magnetic actuator, in particular a magnetic actuator for hydraulic applications, having the magnetic actuator device is proposed.

The method according to the invention, the magnetic actuator device according to the invention and the magnetic actuator according to the invention are here not restricted to the above-described application and embodiment. In particular, the method according to the invention, the magnetic actuator device according to the invention and the magnetic actuator according to the invention may, in order to fulfil a function described herein, comprise a number of individual method steps, elements, components and units deviating from a number cited herein.

### DRAWINGS

Further advantages arise from the following description of the drawings. The drawings show two exemplary embodiments of the invention. The drawings, the description and the claims contain numerous features in combination. The person skilled in the art will where appropriate also consider the features individually and combine these into suitable further combinations.

In the drawings:

FIG. 1 shows a schematic sectional view of a magnetic actuator with a magnetic actuator device,

FIG. 2 shows a schematic, detail, sectional view of the magnetic actuator device with a core tube and with a separating element,

FIG. 3 shows a schematic sectional view of the core tube in partially produced state, i.e. as a partially machined core tube blank,

FIG. 4 shows a schematic flow diagram of a method for production of the core tube magnetically separated by the separating element,

FIG. 5 shows a schematic sectional view of a second variant of the core tube in partially produced state, i.e. as a partly machined alternative core tube blank,

FIG. 6 shows a schematic, detail, section view of an alternative magnetic actuator device with an alternative core tube and an alternative separating element, and

FIG. 7 shows an extract of a schematic sectional view of the magnetic actuator device with the core tube and with an alternative separating element.

### DESCRIPTION OF EXEMPLARY EMBODIMENTS

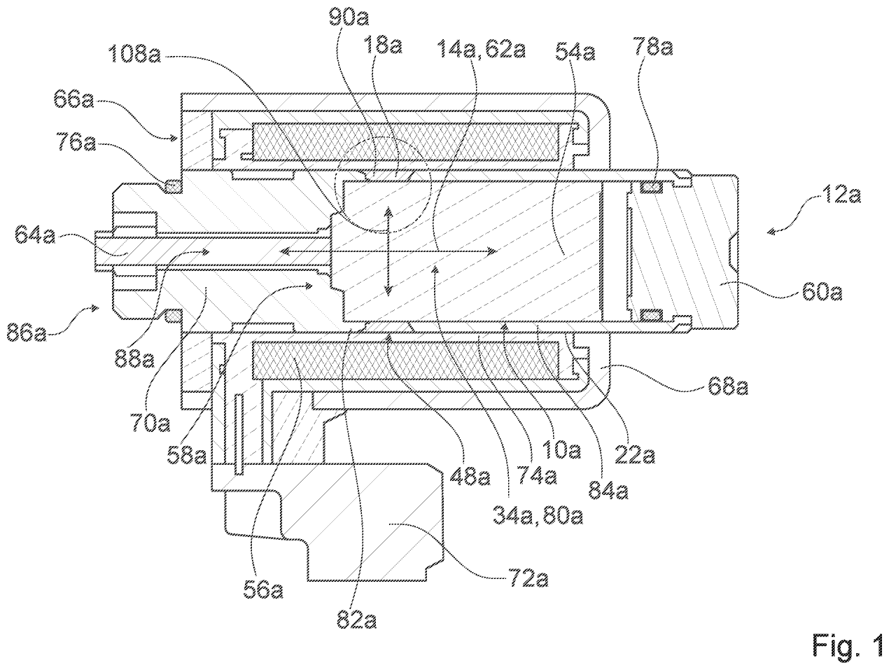

FIG. 1 shows a schematic sectional view of a magnetic actuator 12a. The magnetic actuator 12a is intended for hydraulic applications. The magnetic actuator 12a comprises a magnetic armature 54a. A fluid, in particular a hydraulic fluid (not shown), flows around the magnetic armature 54a. The magnetic armature 54a is made at least for the most part of a magnetic, in particular ferromagnetic material, for example a magnetic steel. The magnetic actuator 12a comprises a magnetic coil 56a. The magnetic coil 56a comprises a winding body 74a. The magnetic coil 56a comprises a plurality of coil windings (not shown). The coil windings are wound onto the winding body 74a. The coil windings of the magnetic coil 56a are wound around a coil axis 62a of the magnetic coil 56a. The magnetic coil 56a is designed to generate a magnetic field, which in turn is designed to create a movement of the magnetic armature 54a. The magnetic armature 54a is configured to move in directions parallel to the coil axis 62a. The magnetic armature 54a is made of a material conducting the magnetic field of the magnetic coil 56a and bundling the magnetic field of the magnetic coil 56a. The magnetic coil 56a has a coil interior 58a. A majority of a movement path of the magnetic armature 54a runs inside the coil interior 58a. The magnetic actuator 12a comprises a tappet element 64a. The tappet element 64a is designed to transmit a movement of the magnetic armature 54a towards the outside (out of the magnetic actuator 12a). The tappet element 64a is actively connected to the magnetic armature 54a. The tappet element 64a follows a movement of the magnetic armature 54a. The tappet element 64a is movable parallel to the coil axis 62a. The magnetic actuator 12a comprises a magnet yoke 66a. The magnet yoke 66a at least partly surrounds the magnetic coil 56a on an outside of the magnetic coil 56a. The magnetic actuator 12a comprises an actuator housing 68a. The actuator housing 68a delimits the magnetic actuator 12a towards the outside. The magnetic actuator 12a comprises a plug element 72a. The plug element 72a is configured for a current connection of the magnetic actuator 12a, in particular the magnetic coil 56a. The plug element 72a is shown purely as an example and may have various designs depending on application or field of use.

The magnetic actuator 12a has a magnetic actuator device 48a. The magnetic actuator device 48a has a core tube 10a. The core tube 10a is made at least for the most part of a magnetic, in particular ferromagnetic material, e.g. a magnetic steel. The core tube 10a is made of a material conducting the magnetic field of the magnetic coil 56a and bundling the magnetic field of the magnetic coil 56a. The core tube 10a may be formed at least for the most part from an identical material to that of the magnetic armature 56a. Alternatively, the core tube 10a and the magnetic armature 54a may be made of different materials. The core tube 10a extends along the coil axis 62a of the magnetic coil 56a. The core tube 10a is arranged at least for the most part in the coil interior 58a of the magnetic coil 56a. The core tube 10a is immovable relative to the magnetic coil 56a. The core tube 10a has a longitudinal direction 14a. The longitudinal direction 14a of the core tube 10a runs at least substantially parallel to the coil axis 62a of the magnetic coil 56a.

The core tube 10a is sealed pressure-tightly towards the outside. For pressure-tight sealing of the core tube 10a, the magnetic actuator device 48a has two O-rings 76a, 78a which seal the core tube 10a pressure-tightly at opposite ends. One of the O-rings 76a seals the magnetic actuator 12a on a connection side 86a of the magnetic actuator 12a, for example against a hydraulic system to which the magnetic actuator 12a is connected.

The magnetic actuator device 48a comprises an armature stop element 60a. The armature stop element 60a is configured to limit a movement of the magnetic armature 58a in at least one direction parallel to the longitudinal direction 14a of the core tube 10a. The core tube 10a forms an armature receiving recess 34a. The magnetic armature 54a is received in the armature receiving recess 34a. The core tube 10a forms a stroke volume 80a. The stroke volume 80a predefines a movement space for the magnetic armature 54a. The armature stop element 60a delimits the stroke volume 80a on one side. The armature stop element 60a is in particular made of a metal. The armature stop element 60a is connected to an end region of the core tube 10a, preferably by press fit and/or form fit. The connection between an interior of the core tube 10a and the armature stop element 60a is sealed pressure-tightly by means of the O-ring 78a.

The magnetic actuator device 48a has a magnetic core 70a. The core tube 10a transforms into a magnetic core 70a at one end. The core tube 10a transforms into the magnetic core 70a on a side opposite the armature stop element 60a.

The magnetic armature 58a is completely received inside the core tube 10a. The tappet element 64a is partially received in the core tube 10a. The tappet element 64a is partially received in the magnetic core 70a. The tappet element 64a emerges from the magnetic core 70a at the connection side 86a. The core tube 10a is largely tubular. The magnetic core 70a has a tappet receiving recess 88a which is configured to receive the tappet element 64a in a mounted state of the magnetic actuator 12. The core tube 10a adjoining the magnetic armature 70a forms, at least for the most part, the stroke volume 80a for the magnetic armature 54a.

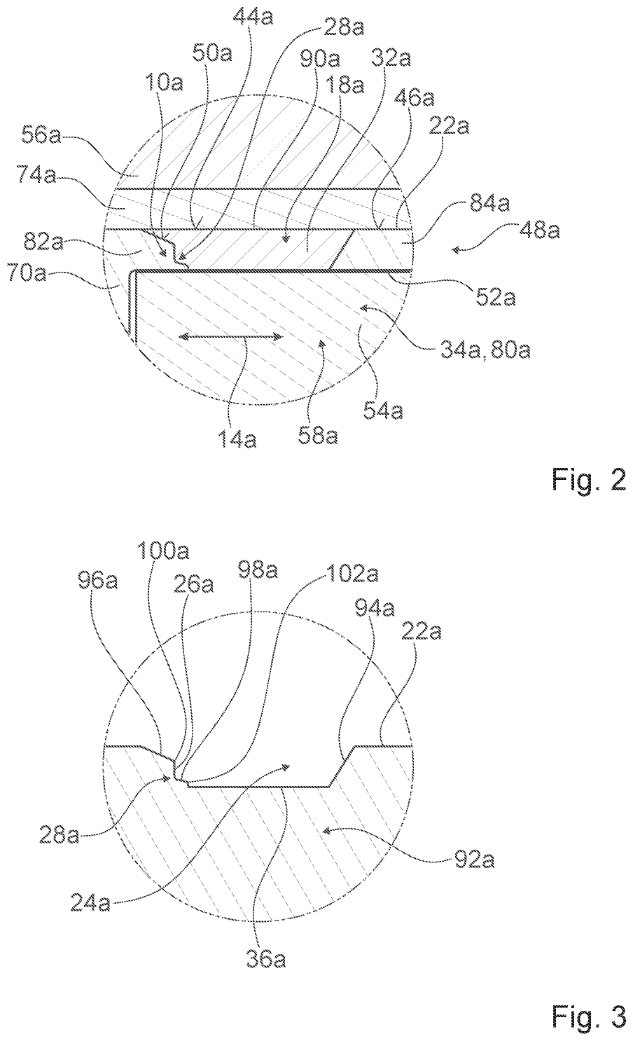

FIG. 2 shows schematically an extract of the magnetic actuator 12a marked by a circle in FIG. 1. The core tube 10a is completely magnetically separated along the longitudinal direction 14a. The magnetic actuator device 48a has a separating element 18a. The separating element 18a completely separates the core tube 10a into two disconnected parts, in particular parts which are not connected together either physically or magnetically, in particular into two part regions 82a, 84a of the core tube 10a. The separating element 18a is inserted between the two parts, in particular part regions 82a, 84a of the core tube 10a. The separating element 18a is connected by substance bonding to the two parts, in particular part regions 82a, 84a of the core tube 10a. On opposite sides of the separating element 18a, the separating element 18a is connected by substance bonding to the two parts, in particular part regions 82a, 84a of the core tube 10a. The separating element 18a is connected pressure-tightly to the two parts, in particular part regions 82a, 84a of the core tube 10a. The separating element 18a forms a pressure-tight magnetic separation of the core tube 10a into two parts, in particular part regions 82a, 84a. The separating element 18a extends from an outer circumference 22a of the core tube 10a to an inner circumference 52a of the armature receiving recess 34a.

The separating element 18a is tubular, in particular formed as a tube portion. The separating element 18a is inserted in the core tube 10a by substance bonding by means of a laser powder deposition welding. The separating element 18a is made of a non-magnetic material 32a. The separating element 18a is made of a non-ferromagnetic material. The separating element 18a poorly conducts or does not conduct the magnetic field of the magnetic coil 56a.

The core tube 10a has an interface 50a to the separating element 18a. The separating element 18a is connected by substance bonding to the interface 50a of the core tube 10a. The core tube 10a has a magnetic field conduction contour 28a at the interface 50a. The magnetic field conduction contour 28a runs around the core tube 10a. The magnetic field conduction contour 28a forms a cone geometry for influencing a force-travel curve of the magnetic actuator 12a having the core tube 10a. The magnetic field conduction contour 28a forms a cone geometry for influencing the force-travel curve of the magnetic armature 54a. The first part region 82a of the core tube 10a, in particular the part region 82a of the core tube 10a transforming into the magnetic core 70a, forms the magnetic field conduction contour 28a. The magnetic field conduction contour 28a is arranged on a side facing away from the connection side 86a, of a part of the core tube 10a in particular of the first part region 82a of the core tube 10a, preferably of the magnetic core 70a. The second part region 84a of the core tube 10a, in particular the part of the core tube 10a forming the armature receiving recess 34a of the core tube 10a, is free from a magnetic field conduction contour in the example shown in the figures. The separating element 18a is arranged in a region of the armature receiving recess 34a of the core tube 10a. The separating element 18a is arranged in a region of the magnetic actuator 12a in which the core tube 10a surrounds the armature receiving recess 34a.

The core tube 10a may be embodied as a drilled or turned tube, i.e. in particular a tube in which the armature receiving recess 34a and/or the tappet receiving recess 88a are produced by material-removal machining of a (solid) core tube blank 92a, or as a drawn tube, i.e. in particular as a tube in which the armature receiving recess 34a and/or the tappet receiving recess 88a are produced without material-removal machining of a (solid) core tube blank 92a.

The core tube 10a has a surface 46a on the outer circumference 22a. The separating element 18a has a surface 44a on an outer circumference 90a of the separating element 18a. The separating element 18a is inserted in the core tube 10a so precisely that the surface 44a of the separating element 18a and the surface 46a of the core tube 10a transform evenly into one another. A transition of the surfaces 44a, 46a of the core tube 10a and separating element 18a is substantially shoulderless.

FIG. 3 shows a schematic sectional view of a part region, corresponding to the extract in FIG. 2, of a first variant of a core tube blank 92a which has already been partly machined (by production of a groove 24a). The core tube blank 92a is made from a cylindrical solid material. The core tube blank 92a has the groove 24a. The groove 24a runs around the core tube blank 92a. The groove 24a is turned into the core tube blank 92a. The groove 24a has side boundaries 26a, 94a. One of the side boundaries 26a forms the magnetic field conduction contour 28a. The magnetic field conduction contour 28a comprises for example two (different) steps 96a, 98a. The magnetic field conduction contour 28a comprises for example two (different) radii 100a, 102a. Further magnetic field conduction contours, which substantially differ from the magnetic field conduction contour 28a illustrated, are evidently conceivable. The groove 24a has a groove bottom 36a.

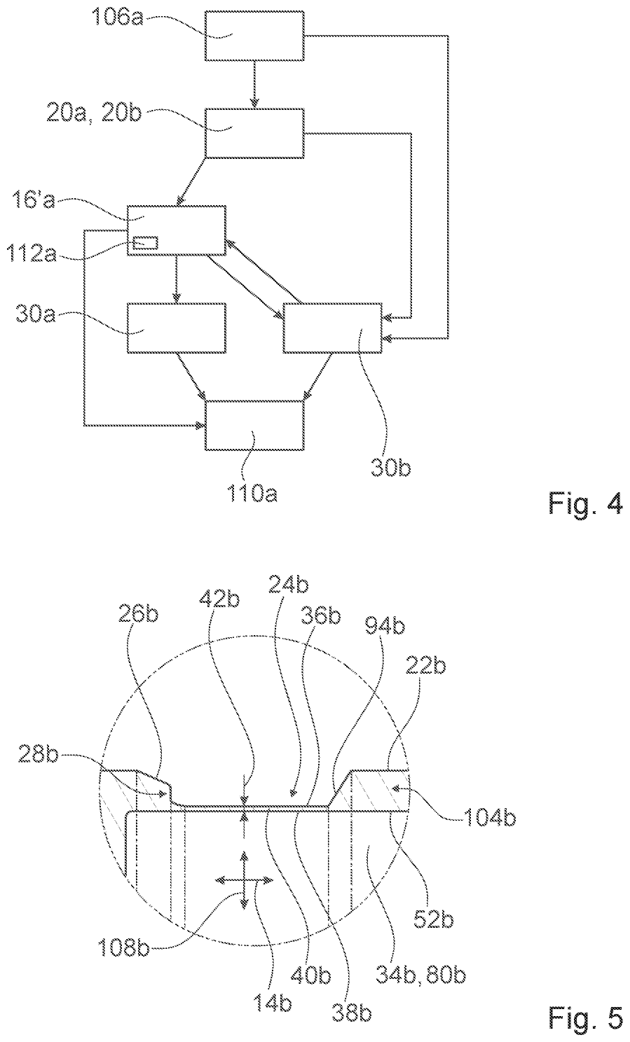

FIG. 4 shows a schematic flow diagram of a method for production of the core tube 10a, which is magnetically separated by the separating element 18a, for the magnetic actuator 12a. In at least one method step 106a, the core tube blank 92a is provided. In a preparatory step 20a, the core tube blank 92a is provided with the circumferential groove 24a on its outer circumference 22a. In the preparatory step 20a, the side boundary 26a of the groove 24a is provided with the magnetic field conduction contour 28a. The magnetic field conduction contour 28a will form the cone geometry of the finished core tube 10a, which is configured for targeted influencing of the force-travel curve of the magnetic actuator 12a having the core tube 10a. The magnetic field conduction contour 28a is turned into the core tube blank 92a during the preparatory step 20a.

In a method step 16′a, the separating element 18a, which produces the magnetic separation of the core tube 10a and is made of non-magnetic material 32a, is inserted in the core tube 10a by substance bonding by means of a laser powder deposition welding. In the method step 16′a, the separating element 18a is inserted in the circumferential groove 24a, produced during the preparatory step 20a, by means of the laser powder deposition welding.

In the method step 16′a, the non-magnetic material 32a in powder form is blown into the laser beam, whereupon the non-magnetic material 32a blown into the laser beam is melted by the laser beam. Then in the method step 16′a, the non-magnetic material 32a in already melted form is introduced into the groove 24a of the core tube blank 92a.

The powdery non-magnetic material 32a, which is blown into the laser beam and melted in the laser beam in the method step 16′a, is implemented as a non-magnetic metal powder. The separating element 18a, inserted during the method step 16′a, is inserted in the groove 24a of the core tube 10a by means of the laser powder deposition welding process so precisely that the surface 44a of the separating element 18a and the surface 46a of the core tube 10a transform evenly into one another. In at least one method step 112a, after completed insertion and at least partial hardening of the separating element 18a, the laser beam or a further laser beam is again passed over the surface 44a of the separating element 18a. Thus the surface 44a of the separating element 18a is smoothed and/or equalized by further, at least partial melting of the separating element 18a. The entire production process can thereby advantageously be free of any material-removal machining steps on the outer circumference 22a of the core tube 10a and on the outer circumference 90a of the separating element 18a.

In at least one further method step 30a, after insertion of the separating element 18a in the groove 24a of the core tube blank 92a, the armature receiving recess 34a, which extends beyond the groove 24a in the longitudinal direction 14a, is produced in the core tube blank 92a. In the further method step 30a, the armature receiving recess 34a is drilled or turned into the core tube blank 92a. In the further method step 30a, the core tube blank 92a is hollowed out as far as the groove bottom 36a of the groove 24a during production of the armature receiving recess 34a, whereby the two part regions 82a, 84a of the core tube 10a are completely (physically and magnetically) separated from one another. In this case, after performance of the further method step 30a, no further (magnetic) core tube material is present above or below the separating element 18a in the radial direction 108a of the core tube 10a.

In a further method step 30b, performed as an alternative to the further method step 30a, a core tube blank 92b is hollowed out during production of an armature receiving recess 34b only so far that a thin web 40b of the (magnetic) material of the core tube blank 92b remains between a groove bottom 36b of a groove 24b of the core tube blank 92b and an inner surface 38b of the produced armature receiving recess 34b. The remaining web 40b here has a thickness 42b of less than 0.5 mm and preferably less than 0.2 mm. The performance of the alternative further method step 30b, in which the thin web 40b is obtained, may be carried out before the method step 16a, 16′a in which the laser powder deposition welding of the separating element 18a takes place, or after the method step 16a, 16′a in which the laser powder deposition welding of the separating element 18a takes place.

Also, in addition, alternatively in the case of retaining the thin web 40b below the separating element 18b, the alternative further method step 30b, i.e. hollowing out of the core tube blank 92b, may be completely omitted if an alternatively designed core tube blank 104b in the form of a drawn tube is used. Here, in the preparatory step 20b, the groove 24b is made in the core tube blank 104b, which is already formed as a drawn tube and thereby already has an armature receiving recess 34b, such that the thin web 40b remains after performance of the preparatory step 20b.

In at least one further method step 110a, the completed core tube 10a, which is magnetically at least substantially separate, is mounted in a magnetic actuator 12a.

FIGS. 4 (partly), 5 and 6 show a further exemplary embodiment of the invention. The following descriptions and the drawings are restricted substantially to the differences between the exemplary embodiments, wherein in principle reference may be made to the drawings and/or descriptions of the other exemplary embodiments, in particular in FIG. 1 to 4 or 7, with respect to components of the same designation, in particular with respect to components with the same reference signs. For distinction between the exemplary embodiments, the letter “a” is added as a suffix to the reference signs of the exemplary embodiments in FIGS. 1, 2, 3, 4 (partly) and 7. In the exemplary embodiment of FIGS. 4 (partly), 5 and 6, the letter “a” has been replaced by the letter “b”.

FIG. 5 shows a schematic sectional view of a part region, corresponding to the extract from FIG. 2, of a second variant of a core tube blank 104b which has already been partly machined (by production of a groove 24b). The core tube blank 104b is made from a cylindrical tube. The core tube blank 104b is made from a drawn cylindrical tube. The core tube blank 104b is made from a seamlessly drawn cylindrical tube. The core tube blank 104b comprises an inner circumference 52b and an outer circumference 22b. The core tube blank 104b has the groove 24b. The groove 24b extends from the outer circumference 22b towards the inner circumference 52b. The groove 24b does not however penetrate the tube wall of the core tube blank 104b. The groove 24b runs around the core tube blank 104b. The groove 24b is turned into the core tube blank 104b. The groove 24b has side boundaries 26b, 94b. One of the side boundaries 26b forms a magnetic field conduction contour 28b. The groove 24b has a groove bottom 36b. Between the groove bottom 36b and the inner circumference 52b of the core tube blank 104b is a thin web 40b consisting of the material of the core tube blank 104b. The web 40b has a thickness 42b of less than 0.5 mm.

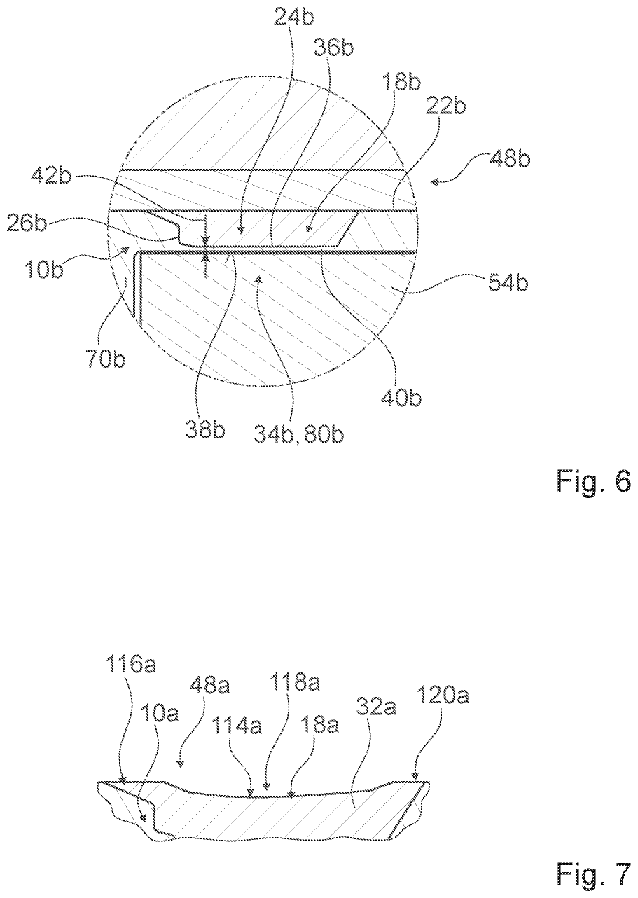

FIG. 6 shows an extract, corresponding to the extract from FIG. 2, of an alternative magnetic actuator 12b with an alternative magnetic actuator device 48b. The alternative magnetic actuator device 48b has an alternative separating element 18b and an alternative core tube 10b. The separating element 18b extends from an outer circumference 22b of the core tube 10b towards an armature receiving recess 34b formed by the core tube 10b. The separating element 18b is separated from the armature receiving recess 34b by the thin web 40b which is formed by the core tube 10b and has a thickness 42b of less than 0.5 mm. In energized state of the magnetic actuator 12b, the thin web 40b very quickly reaches complete magnetic field saturation, so the force-travel curve of the magnetic actuator 12b is not or only insignificantly influenced or adversely affected by the thin web 40b.

FIG. 7 shows schematically an extract of the magnetic actuator device 48a with the core tube 10a and the separating element 18a. The separating element 18a transforms evenly into the core tube 10a in the edge regions 116a, 120a. The separating element 18a has a tapering 114a in the middle region 118a.

### REFERENCE SIGNS

10 Core tube
12 Magnetic actuator
14 Longitudinal direction
16 Method step
18 Separating element
20 Preparatory step
22 Outer circumference
24 Groove
26 Side boundary
28 Magnetic field conduction contour
30 Further method step
32 Non-magnetic material
34 Armature receiving recess
36 Groove bottom
38 Inner surface
40 Web
42 Thickness
44 Surface
46 Surface
48 Magnetic actuator device
50 Interface
52 Inner circumference
54 Magnetic armature
56 Magnetic coil
58 Coil interior
60 Armature stop element
62 Coil axis
64 Tappet element
66 Magnet yoke
68 Actuator housing
70 Magnetic core
72 Plug element
74 Winding body
76 O-ring
78 O-ring
80 Stroke volume
82 Part region
84 Part region
86 Connection side
88 Tappet receiving recess
90 Outer circumference
92 Core tube blank
94 Side boundary
96 Step
98 Step
100 Radius
102 Radius
104 Core tube blank
106 Method step
108 Radial direction
110 Method step
112 Method step
114 Tapering
116 Edge region
118 Middle region
120 Edge region

1. A method for producing a core tube for a magnetic actuator, which has, at least along a longitudinal direction of the core tube, a preferably pressure-tight magnetic separation, wherein, in at least one method step, a separating element, which produces the magnetic separation of the core tube and is made of a non-magnetic material, is inserted into the core tube -by material bonding by means of laser-powder deposition welding, and wherein, in at least one preparatory step, a core tube blank is provided on its outer circumference with a circumferential groove into which the separating element is inserted in the method step, wherein in the method step, the non-magnetic material is blown in powder form into a laser beam, is melted in the laser beam and then in already melted form is introduced into the groove.

2. The method as claimed in claim 1, wherein in the preparatory step, at least one side boundary of the groove is provided with a magnetic field conduction contour (28a; 28b), which in particular will form a cone geometry of the completed core tube for influencing a force-travel curve of the magnetic actuator having the core tube.

3. The method as claimed in claim 1, wherein in the method step, the powdery non-magnetic material blown into the laser beam and melted in the laser beam is realized as a non-magnetic metal powder.

4. The method as claimed in claim 1, wherein in at least one further method step, after insertion of the separating element into the groove, an armature receiving recess is produced in the core tube blank and preferably extends beyond the groove in the longitudinal direction.

5. The method as claimed in claim 4, wherein in the further method step, on production of the armature receiving recess, the core tube blank is hollowed out down to a groove bottom of the groove.

6. The method as claimed in claim 4, wherein in the further method step, on production of the armature receiving recess, the core tube blank is hollowed out until only a thin web of the material of the core tube blank remains between a groove bottom of the groove and an inner surface of the armature receiving recess, in particular a web with a thickness of less than 0.5 mm and preferably less than 0.2 mm.

7. The method as claimed in claim 6, wherein the hollowing-out of the core tube blank is executed before performance of the method step with the laser powder deposition welding.

8. The method as claimed in claim 1, wherein the core tube blank, in which the groove is produced during the preparatory step, is embodied as a drawn tube which already has an armature receiving recess.

9. The method as claimed in claim 1, wherein in the method step, the separating element is inserted in a groove of the core tube so precisely that a surface of the separating element and a surface of the core tube transform evenly into one another.

10. The method as claimed in claim 1, wherein in at least one method step, after completion of the insertion and at least partial hardening of the separating element, the laser beam or a further laser beam is again passed over a surface of the separating element in order thereby to smooth and/or equalize the surface of the separating element by a further, at least partial melting of the separating element.

11. A magnetic actuator device, in particular produced using a method as claimed in claim 1, with at least one core tube, which is at least substantially magnetically separated along its longitudinal direction by an, in particular pressure-tight, separating element, outer circumference,
wherein the separating element is inserted by substance bonding into the core tube by means of a laser powder deposition welding, in which a non-magnetic material is blown in powder form into a laser beam, is melted in the laser beam and then in already melted form is introduced into a circumferential groove situated on an outer circumference of a core tube blank.

12. The magnetic actuator device as claimed in claim 11, wherein the core tube, at an interface to the separating element, has an, in particular circumferential, magnetic field conduction contour, which in particular forms a cone geometry for influencing a force-travel curve of a magnetic actuator having the core tube.

13. The magnetic actuator device as claimed in claim 11, wherein the separating element is arranged in a region of an armature receiving recess of the core tube.

14. The magnetic actuator device as claimed in claim 13, wherein the separating element extends from an outer circumference of the core tube to an inner circumference of the armature receiving recess.

15. The magnetic actuator device as claimed in claim 13, wherein the separating element (18b extends from an outer circumference of the core tube towards the armature receiving recess, wherein the separating element is separated from the armature receiving recess by a thin web formed by the core tube, in particular with a thickness of less than 0.5 mm, preferably less than 0.2 mm.

16. A magnetic actuator, in particular a magnetic actuator for hydraulic applications, having a magnetic actuator device as claimed in claim 11.
